(19) United States
(12) Patent Application Publication
(10) Pub. No.: US 2007/0136002 A1
(43) Pub. Date: Jun. 14, 2007

(54) Method and system for synchronizing protein information of PPI network DB

(75) Inventors: Jae Hun Choi, Daejeon-city (KR); Jong Min Park, Jeonjoo-city (KR); Myung Eun Lim, Daejeon-city (KR); Seon Hee Park, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/635,579

(22) Filed: Dec. 8, 2006

(30) Foreign Application Priority Data
Dec. 8, 2005 (KR) 10-2005-0119281
Mar. 17, 2006 (KR) 10-2006-0024787

(51) Int. Cl. G06F 19/00

(52) U.S. Cl. 702/19

(57) ABSTRACT

A method and system for keeping a protein-protein interaction (PPI) network database (DB) up-to-date by synchronizing protein information present in the PPI network DB with protein information present in a public DB which is frequently updated and is provided to the public are provided. The method of synchronizing protein information of a protein-protein interaction (PPI) network database (DB) includes: (a) choosing a protein from a PPI network DB which stores a plurality of pieces of PPI information; (b) receiving up-to-date protein information corresponding to the chosen protein from a global protein DB which stores a plurality of pieces of up-to-date protein information that can be provided to the public, and keeping the local protein DB up-to-date by performing a global synchronization operation on a local protein DB such that protein information which corresponds to the chosen protein and is present in the local protein DB can be updated with the received up-to-date protein information, the local protein DB storing a plurality of pieces of protein information corresponding to the PPI network DB; and (c) receiving updated protein information obtained through the global synchronization operation from the local protein DB, and keeping the PPI network up-to-date by performing a local synchronization operation on the PPI network DB such that protein information which corresponds to the chosen protein and is present in the PPI network DB can be updated with the received updated protein information.

### CROSS-REFERENCE TO RELATED PATENT APPLICATION

This application claims the benefit of Korean Patent Application Nos. 10-2005-0119281, filed on Dec. 8, 2005 and 10-2006-0024787, filed on Mar. 17, 2006 in the Korean Intellectual Property Office, the disclosures of which are incorporated herein in its entirety by reference.

### BACKGROUND OF THE INVENTION

1. Field of the Invention

The present invention relates to a method and system for synchronizing protein information of a protein-protein interaction (PPI) network.

2. Description of the Related Art

A protein-protein interaction (PPI) network DB stores a group of a plurality of pieces of information regarding the interaction among a variety of proteins and includes other essential biological information such as information regarding the transmission of signals between cells, the lifetime and development of cells, DNA replication, and cell metabolism. Since PPI network data can be effectively used in the bioinformatics industry for development of new medicines and medical diagnoses, the importance of such PPI network DB has steadily grown. In general, a considerable amount of PPI network data can be obtained through biological experiments using, for example, Yeast Two-Hybrid. Examples of a PPI network database (DB) include a Biological Interaction Network DB (BIND) and a DB of Interacting Proteins (DIP).

Protein information that can be stored in a PPI network DB is frequently updated. The results of the updating are maintained and managed by a global protein DB such as a Swiss Prot DB or a Gene Bank DB and can be provided to the public via the Internet. However, sometimes, protein information present in the global protein DB provided via the Internet may not be identical to protein information present in the PPI network DB. In order to maintain the PPI network DB, a local protein DB is additionally required. In general, a protein DB manager periodically updates protein information present in the local protein DB with protein information present in the global protein DB.

In the meantime, the time when the PPI network is established, the time when the local protein DB is updated, and the time when the global protein DB is updated may not coincide with one another. Thus, protein information present in the global protein DB, protein information present in the local protein DB, and protein information present in the PPI network may not be identical. However, no specific methods have been developed to synchronize the PPI network DB, the local protein DB, and the global protein DB with one another.

### SUMMARY OF THE INVENTION

The present invention provides a method of synchronizing protein information of a protein-protein interaction (PPI) network database (DB) which can automatically keep a PPI network DB up-to-date.

The present invention also provides a system for synchronizing protein information of a PPI network which can automatically keep a PPI network DB.

According to an aspect of the present invention, there is provided a method of synchronizing protein information of a protein-protein interaction (PPI) network database (DB) including: (a) choosing a protein from a PPI network DB which stores a plurality of pieces of PPI information; (b) receiving up-to-date protein information corresponding to the chosen protein from a global protein DB which stores a plurality of pieces of up-to-date protein information that can be provided to the public, and keeping the local protein DB up-to-date by performing a global synchronization operation on a local protein DB such that protein information which corresponds to the chosen protein and is present in the local protein DB can be updated with the received up-to-date protein information, the local protein DB storing a plurality of pieces of protein information corresponding to the PPI network DB; and (c) receiving updated protein information obtained through the global synchronization operation from the local protein DB, and keeping the PPI network up-to-date by performing a local synchronization operation on the PPI network DB such that protein information which corresponds to the chosen protein and is present in the PPI network DB can be updated with the received updated protein information.

(b) may include: (b1) translating an update request for the chosen protein into an XML-based query; (b2) receiving the up-to-date protein information corresponding to the chosen protein from the global protein DB as HTML-based protein information and analyzing the HTML-based protein information; (b3) packaging the result of the analysis with an XML wrapper; (b4) extracting one or more items needed to update the local protein DB from the result of the packaging; and (b5) updating the local protein DB by integrating the extracted items into the protein information present in the local protein DB.

(c) may include: (c1) filtering out a plurality of proteins which have similar names or genetic properties to the chosen protein or are categorized into similar classes to the class of the chosen protein from the local protein DB; (c2) comparing the names, synonyms, genetic properties, ontological properties, and detailed class information of the filtered-out proteins with the name, synonym(s), genetic properties, ontological properties, and detailed class information of the chosen protein and choosing one of the filtered-out proteins that matches the chosen protein most based on the results of the comparison; (c3) extracting one or more items needed to update the PPI network DB from protein information of the chosen filtered-out protein; and (c4) updating the PPI network DB by integrating the extracted items into the protein information present in the PPI network DB.

According to another aspect of the present invention, there is provided a system for synchronizing protein information of protein-protein interaction (PPI) network database (DB) including: a global protein DB which stores a plurality of pieces of up-to-date protein information that can be provided to the public; a PPI network DB which stores a group of a plurality of pieces of PPI information; a local protein DB which stores a plurality of pieces of protein information corresponding to the PPI network DB; a global synchronizer which receives up-to-date protein information corresponding to a chosen protein from the global protein DB and keeps the local protein DB up-to-date by performing a global synchronization operation on the local protein DB such that protein information which corresponds to the chosen protein and is present in the local protein DB can be updated with the received up-to-date protein information; and a local synchronizer which receives updated protein information obtained through the global synchronization operation from the local protein DB and keeps the PPIN network DB up-to-date by performing a local synchronization operation on the PPI network DB such that protein information which corresponds to the chosen protein and is present in the PPI network DB can be updated with the received updated protein information.

The global synchronizer may translate an update request for the chosen protein into an XML-based query; receive the up-to-date protein information corresponding to the chosen protein from the global protein DB as HTML-based protein information and analyzes the HTML-based protein information; package the result of the analysis with an XML wrapper; extract one or more items needed to update the local protein DB from the result of the packaging; and update the local protein DB by integrating the extracted items into the protein information present in the local protein DB.

The local synchronizer may filter out a plurality of proteins which have similar names or genetic properties to the chosen protein or are categorized into similar classes to the class of the chosen protein from the local protein DB; compare the names, synonyms, genetic properties, ontological properties, and detailed class information of the filtered-out proteins with the name, synonym(s), genetic properties, ontological properties, and detailed class information of the chosen protein and choosing one of the filtered-out proteins that matches the chosen protein most based on the results of the comparison; extract one or more items needed to update the PPI network DB from protein information of the chosen filtered-out protein; and update the PPI network DB by integrating the extracted items into the protein information present in the PPI network DB.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of synchronizing protein information of a protein-protein interaction (PPI) network database (DB) according to an embodiment of the present invention;

FIG. 2 is a flowchart illustrating operation S200 illustrated in FIG. 1 according to an embodiment of the present invention;

FIG. 3 is a flowchart illustrating operation S300 illustrated in FIG. 1 according to an embodiment of the present invention;

FIG. 4 is a block diagram of a system for synchronizing protein information of a PPI network DB according to an embodiment of the present invention; and

FIG. 5 is a block diagram of a system for synchronizing protein information of a PPI network DB according to an embodiment of the present invention for explaining the method illustrated in FIG. 1.

### DETAILED DESCRIPTION OF THE INVENTION

The present invention will now be described more fully with reference to the accompanying drawings in which exemplary embodiments of the invention are shown.

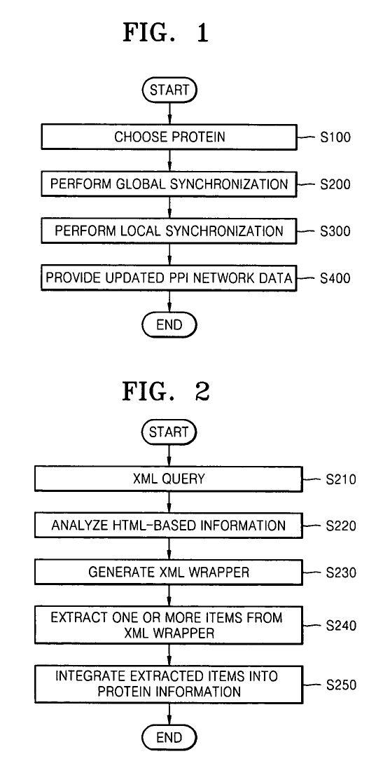

FIG. 1 is a flowchart illustrating a method of synchronizing protein information of a protein-protein interaction (PPI) network database (DB) according to an embodiment of the present invention. Referring to FIG. 1, in operation S100, a protein whose information needs to be updated is chosen from a PPI network DB. The PPI network DB stores a plurality of pieces of PPI information.

Thereafter, in operation S200, up-to-date protein information corresponding to the chosen protein is received from a global protein DB which stores a plurality of pieces of up-to-date protein information that can be provided to the public, and the local protein DB is synchronized with the global protein DB by updating protein information which corresponds to the chosen protein and is stored in a local protein DB corresponding to the PPI network with the up-to-date protein information received from the global protein DB. In this manner, the local protein DB can be kept up-to-date. This type of synchronization operation will now be referred to as a global synchronization operation.

Thereafter, in operation S300, updated protein information obtained through the global synchronization operation is received from the local protein DB, and the PPI network DB is synchronized with the local protein DB by updating protein information which corresponds to the chosen protein and is present in the PPI network DB with the updated protein information. In this manner, the PPI network DB can be kept up-to-date. This type of synchronization operation will now be referred to as a local synchronization operation.

In operation S400, the updated PPI network DB can be provided to a user, if necessary.

According to protein information of a PPI network of the present embodiment, a global synchronization operation and a local synchronization operation can be performed separately and independently from each other to maintain up-to-dateness of the corresponding information.

FIG. 2 is a flowchart illustrating a global synchronization operation, i.e., operation S200 illustrated in FIG. 1, according to an embodiment of the present invention. Referring to FIG. 2, in operation S210, an update query for protein which is chosen to be updated by a user is translated into an XML-based query. In operation S220, a request for up-to-date protein information corresponding to the chosen protein is issued to a global protein DB based on the result of the translation using a GET or POST method, the up-to-date protein information corresponding to the chosen protein is received via the Internet as HTML-based protein information, and the HTML-based protein information is analyzed, and it is determined based on the result of the analysis whether the HTML-based protein information is appropriate. The analysis of the HTML-based protein information may include analyzing error information which is included in the HTML-based protein information and is regarding errors of the Internet or a global protein DB server.

In operation S230, the HTML-based protein information is packaged by an XML wrapper such that it can be easily accessed by a user using XQuery. In operation S240, one or more items needed to update protein information which corresponds to the chosen protein and is present in a local network DB are extracted from the result of the packaging using XQuery. In operation S250, the local protein DB is updated by integrating the extracted items into the protein information which corresponds to the chosen protein and is present in the local protein DB.

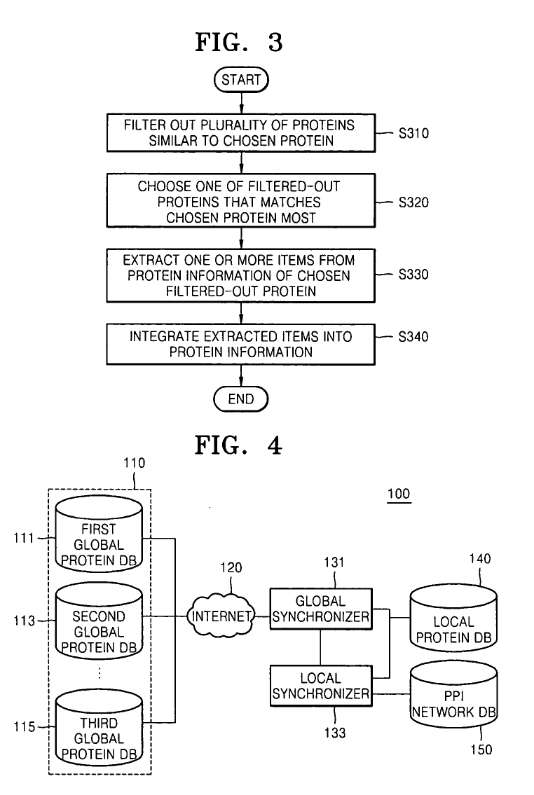

FIG. 3 is a flowchart illustrating a local synchronization operation, i.e., operation S300 illustrated in FIG. 3, according to an embodiment of the present invention. Referring to FIG. 3, in operation S310, a plurality of proteins which have similar names and genetic properties to a protein chosen by a user or are categorized into similar classes to the class of the chosen protein are filtered out from a local protein DB. In operation S320, the names, genetic properties, synonyms, ontological properties, and detailed class information of the filtered-out proteins are compared with the name, genetic properties, synonym(s), ontological properties, and detailed class information of the chosen protein, and one of the filtered-out proteins that matches the chosen protein most is chosen with reference to the results of the comparison. Since protein information which corresponds to the chosen protein and is present in the local protein DB has already been updated through global synchronization, operations S310 and S320 are needed to search for and update protein information which corresponds to the chosen protein and is present in the PPI network DB.

In operation S330, one or more items needed to update the PPI network DB are extracted from protein information of the chosen filtered-out protein. In operation S340, the PPI network DB is updated by integrating the extracted items into protein information present in the PPI network DB.

FIG. 4 is a block diagram of a system 100 for synchronizing protein information of a PPI network DB according to an embodiment of the present invention. Referring to FIG. 4, the system 100 includes a global protein DB 110 which stores a plurality of pieces of up-to-date protein information that can be provided to the public; a PPI network DB 150 which stores a group of a plurality of pieces of PPI information; a local protein DB 140 which stores protein information corresponding to the PPI network DB 150; a global synchronizer 131 which receives up-to-date protein information corresponding to a protein chosen by a user from the global protein DB 110 and keeps the local protein DB up-to-date by performing a global synchronization operation on the local protein DB 140 such that protein information which corresponds to the chosen protein and is present in the local protein DB 140 can be updated with the received up-to-date protein information; and a local synchronizer 133 which receives updated protein information obtained through the global synchronization operation from the local protein DB 140 and keeps the PPI network DB 150 up-to-date by performing a local synchronization operation on the PPI network DB 150 such that protein information which corresponds to the chosen protein and is present in the PPI network DB 150 can be updated with the updated protein information obtained through the global synchronization.

The global protein DB 110 can be provided to the public via, for example, the Internet 120. The global protein DB 110 may be comprised of a plurality of first, second, and third DBs 111, 113, and 115 which are respectively provided by a plurality of providers. The global protein DB 110 may be a Swiss Prot DB or a Gene Bank DB.

The PPI network DB 150 may be established based on a DB of Interacting Proteins (DIP), a Biological Interaction Network DB (BIND), or an INTERACT DB. The global synchronizer 131 converts an update query for a protein chosen by a user into an XML-based query; receives up-to-date protein information corresponding to the chosen protein from the global protein DB 110 as HTML-based information and analysing the HTML-based information; packages the result of the analysis using an XML wrapper; extracts one or more items needed to update the local protein DB 140 from the result of the packaging; and updates the local protein DB 140 by integrating the extracted items into protein information present in the local protein DB 140.

The local synchronizer 133 filters out a plurality of proteins which have similar names or genetic properties to the chosen protein or are categorized into similar classes to the class of the chosen protein from the local protein DB 140; compares the names, synonyms, genetic properties, ontological properties, and detailed class information of the filtered-out proteins with the name, synonym(s), genetic properties, ontological properties, and detailed class information of the chosen protein and choosing one of the filtered-out proteins that matches the chosen protein most based on the results of the comparison; extracts one or more items needed to update the PPI network DB 150 from protein information of the chosen filtered-out protein; and updates the PPI network DB 150 by integrating the extracted items into protein information present in the PPI network DB 150.

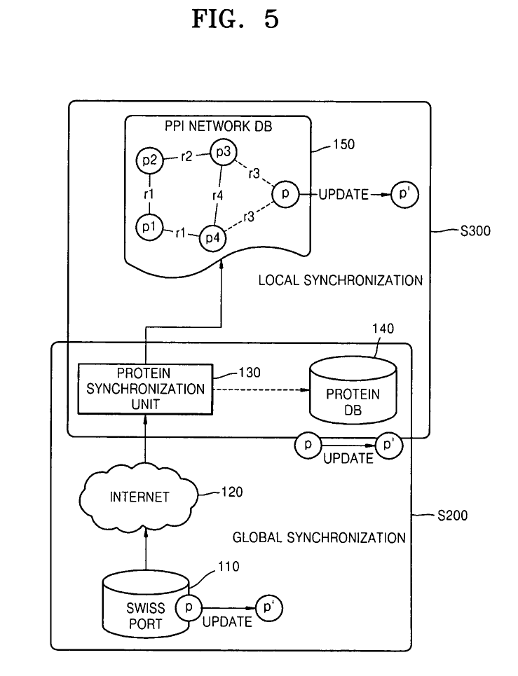

FIG. 5 is a block diagram of a system for synchronizing protein information of a PPI network DB according to an embodiment of the present invention for explaining the method illustrated in FIG. 1. Referring to FIG. 5, in operation S200, if protein information P present in a Swiss Prot DB 110, which is a type of global protein DB, is updated with protein information P′, a protein synchronization unit 130 synchronizes a local protein DB 140 with the Swiss Prot DB 110 by updating protein information P present in the local protein DB 140 with the protein information P′.

In operation S300, the protein synchronization unit 130 synchronizes a PPI network DB 150 with the local protein DB 140, which has been updated through the global synchronization operation performed in operation S200, by updating protein information P present in the PPI network DB 150 with the protein information P′.

Operations S310 and S320 illustrated in FIG. 3 need to be conducted to search the local protein DB 140 for the protein information P′, which is an updated version of the protein information P, because the protein information P previously present in the local protein DB 140 has already been updated with the protein information P′ and thus does not exist in the local protein DB 140 any longer.

The protein synchronization unit 130 may comprise the global synchronizer 131 and the local synchronizer 133 illustrated in FIG. 4. The global synchronizer 131 and the local synchronizer 133 can operate independently from each other. In other words, if the PPI network DB 150 still holds the protein information P after the updating of the local protein DB 140, the local synchronizer 133 can automatically update the protein information P present in the PPI network DB 150 with the protein information P′. Also, the protein information P present in the local protein DB 140 can be updated with the protein information P′ by using the local protein DB 140 only.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

As described above, according to the present invention, protein information present in a PPI network DB can be kept up-to-date by synchronizing the protein information present in the PPI network DB with protein information present in a global protein DB. Therefore, it is possible to address the problem with the prior art in that PPI network data must be manually updated whenever protein information is updated. In addition, it is possible to keep the PPI network DB up-to-date automatically.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of synchronizing protein information of a protein-protein interaction (PPI) network database (DB) comprising:
(a) choosing a protein from a PPI network DB which stores a plurality of pieces of PPI information;
(b) receiving up-to-date protein information corresponding to the chosen protein from a global protein DB which stores a plurality of pieces of up-to-date protein information that can be provided to the public, and keeping the local protein DB up-to-date by performing a global synchronization operation on a local protein DB such that protein information which corresponds to the chosen protein and is present in the local protein DB can be updated with the received up-to-date protein information, the local protein DB storing a plurality of pieces of protein information corresponding to the PPI network DB; and
(c) receiving updated protein information obtained through the global synchronization operation from the local protein DB, and keeping the PPI network up-to-date by performing a local synchronization operation on the PPI network DB such that protein information which corresponds to the chosen protein and is present in the PPI network DB can be updated with the received updated protein information.

2. The method of claim 1, wherein (b) comprises:
(b1) translating an update request for the chosen protein into an XML-based query;
(b2) receiving the up-to-date protein information corresponding to the chosen protein from the global protein DB as HTML-based protein information and analyzing the HTML-based protein information;
(b3) packaging the result of the analysis with an XML wrapper;
(b4) extracting one or more items needed to update the local protein DB from the result of the packaging; and
(b5) updating the local protein DB by integrating the extracted items into the protein information present in the local protein DB.

3. The method of claim 1, wherein (c) comprises:
(c1) filtering out a plurality of proteins which have similar names or genetic properties to the chosen protein or are categorized into similar classes to the class of the chosen protein from the local protein DB;
(c2) comparing the names, synonyms, genetic properties, ontological properties, and detailed class information of the filtered-out proteins with the name, synonym(s), genetic properties, ontological properties, and detailed class information of the chosen protein and choosing one of the filtered-out proteins that matches the chosen protein most based on the results of the comparison;
(c3) extracting one or more items needed to update the PPI network DB from protein information of the chosen filtered-out protein; and
(c4) updating the PPI network DB by integrating the extracted items into the protein information present in the PPI network DB.

4. A system for synchronizing protein information of protein-protein interaction (PPI) network database (DB) comprising:
a global protein DB which stores a plurality of pieces of up-to-date protein information that can be provided to the public;
a PPI network DB which stores a group of a plurality of pieces of PPI information;
a local protein DB which stores a plurality of pieces of protein information corresponding to the PPI network DB;
a global synchronizer which receives up-to-date protein information corresponding to a chosen protein from the global protein DB and keeps the local protein DB up-to-date by performing a global synchronization operation on the local protein DB such that protein information which corresponds to the chosen protein and is present in the local protein DB can be updated with the received up-to-date protein information; and
a local synchronizer which receives updated protein information obtained through the global synchronization operation from the local protein DB and keeps the PPIN network DB up-to-date by performing a local synchronization operation on the PPI network DB such that protein information which corresponds to the chosen protein and is present in the PPI network DB can be updated with the received updated protein information.

5. The system of claim 4, wherein the global synchronizer translates an update request for the chosen protein into an XML-based query; receives the up-to-date protein information corresponding to the chosen protein from the global protein DB as HTML-based protein information and analyzes the HTML-based protein information; packages the result of the analysis with an XML wrapper; extracts one or more items needed to update the local protein DB from the result of the packaging; and updating the local protein DB by integrating the extracted items into the protein information present in the local protein DB.

6. The system of claim 4, wherein the local synchronizer filters out a plurality of proteins which have similar names or genetic properties to the chosen protein or are categorized into similar classes to the class of the chosen protein from the local protein DB; compares the names, synonyms, genetic properties, ontological properties, and detailed class information of the filtered-out proteins with the name, synonym(s), genetic properties, ontological properties, and detailed class information of the chosen protein and choosing one of the filtered-out proteins that matches the chosen protein most based on the results of the comparison; extracts one or more items needed to update the PPI network DB from protein information of the chosen filtered-out protein; and updates the PPI network DB by integrating the extracted items into the protein information present in the PPI network DB.
